(19) United States
(12) Patent Application Publication
(10) Pub. No.: US 2009/0104313 A1
(43) Pub. Date: Apr. 23, 2009

(54) Nutrient-enhanced alcoholic beverage formulations and methods of making the same

(76) Inventor: Brian Lottig, Westlake, OH (US)

Correspondence Address: FLASTER/GREENBERG P.C.;8 PENN CENTER, 1628 JOHN F. KENNEDY BLVD., 15TH FLOOR, PHILADELPHIA, PA, 19103, US

(21) Appl. No.: 11/975,300

(22) Filed: Oct. 18, 2007

(51) Int. Cl. A23L 1/302; C12C 5/02; C12G 1/00; C12G 3/04

(52) U.S. Cl. 426/72; 426/592

(57) ABSTRACT

An alcoholic beverage is disclosed having an alcoholic formulation and a vitamin selected from thiamine (B1), allithiamine and combinations thereof. The alcoholic formulation can be beer, wine, liquor/spirits or mixer formulations for mixing with liquor/spirits. Also disclosed are methods for adding nutrients to alcoholic beverage formulations.

### BACKGROUND OF THE INVENTION

1. Field of the Invention

The invention is directed to the field of alcoholic beverages, specifically to providing a nutrient-enhanced alcoholic beverage.

2. Description of Related Art

There is a large economic impact associated with alcoholic hangovers in terms of, for example, missed work and/or decreased productivity. These losses can be significant, and have been estimated to reach approximately $3.3 billion in Britain, $8.9 billion in Canada, $3.8 billion in Australia, and $148 billion in the United States. Wiese, J. G., Shlipak, M. G., and Browner, W. S., “The Alcohol Hangover,” Annals of Internal Medicine, 132(11): 897-902 (2000). Further, many of the health issues that stem from alcohol consumption result from nutrient deficiencies. For example, nutrient deficiency and its relationship to Wernicke-Korsakoff Syndrome, a neurological disorder associated with alcohol consumption, is well documented. See, Thiamine Addition to Alcohol, Report 3 of the Council on Scientific Affairs (1-96), American Medical Association. In the U.S., the recommendations are to add thiamine to beer at 7.5 mg/l, to wine at 15 mg/l and to spirits at 60 mg/l. While various medical groups in the U.S., Australia, and Scotland have all issued recommendations for fortifying the nutritional value of alcoholic beverages to combat negative health effects, such products do not appear to be available and there is not yet a government mandate for the fortification of alcoholic beverages. Further, there is no guidance on how to process such a formulation, whether the recommended amounts would be successful and how to maintain flavor and other desirable properties of the beverage when providing nutrients to alcoholic beverages.

Research work of Stacey and Sullivan shows that one such nutrient, thiamine, has no discernible effects on the flavor of beer. Stacey, P. S. and Sullivan, K. A., “Detecting Thiamine in Beer,” Alcohol & Alcoholism, Vol. 38, No. 4, pp. 376-380 (2003). The beer industry, however, has expressed resistance to such nutrient-enhancement based on concerns that such changes may lead to flavor alteration of existing products. Because of the political controversy in the U.S. that surrounds a “healthy” alcoholic beverage, there is also a lack of clinical research as to the true benefits of fortifying drinks. Taking into account both the enjoyment that responsible alcohol consumption can bring and the costs associated with consumption and manufacture, there is a need to develop formulations that will meet or exceed the recommendations of health care professionals in the aforementioned countries while not compromising the flavor integrity that the alcohol industry has earned and that are economical to manufacture.

Premier Research Labs provides a B-vitamin complex sold under the trade name Max Stress B™ Nano-Plex. The complex includes B-vitamins, which are present in low concentrations in the complex (B₁—1.7 mg, B₂—1.7 mg, B₃—25 mg, B₅—2.6 mg, B₆—2.6 mg, B₁₂—600 μg, folic acid—417 μg, PABA—12.5 mg, biotin—338 μg, and inositol—138.8 mg, each per 2.5 ml dose). Dr. Robert Marshall, of Premier Research Labs recommends using this vitamin complex for patients undergoing alcohol detoxification treatment. He has also suggested in the past to the inventor herein adding this complex with very high doses of L-glutamine to beer, i.e., about 35.7 mg L-glutamine/g of ethanol in beer. However, while the noted vitamin complex may be useful as an oral supplement for patients undergoing alcohol detoxification treatment, they do not work in a beer or alcoholic beverage matrix for several reasons.

First, the level of L-glutamine must be controlled to avoid developing an overly astringent flavor in the resulting beer beverage. At high concentrations, astringency can render the resulting beer unpalatable. Further, the B-vitamin complex suggested has several issues that make it unacceptable as an alcoholic beverage additive. Dosing the above-noted concentrations in 2.5 ml into a bottle of beer (approximately 355 ml) will yield such low quantities of B-vitamins that the use of this complex is ineffective. Further, this vitamin complex uses living bacteria as part of the matrix, specifically bacteria known to cause acidic spoilage in the beverage industry. Adding this ingredient will spoil the batch it is added to, making it unpalatable.

Metabolism of Ethanol

The liver is the primary organ for metabolism of alcohol accounting for approximately 90-95% of its removal. The remainder is lost through excretion and perspiration. The damage from alcohol is thought to relate to acetaldehyde buildup in the body, an intermediate compound of ethanol metabolism, and a free radical as shown by the mechanism below:

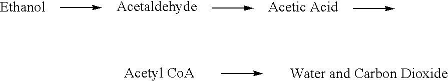

Without sufficient thiamine, the acetaldehyde to acetic acid conversion does not take place and acetaldehyde builds up in the body causing damage to the liver and being substantially responsible for hangovers. See, e.g., Jung, T. W. et al., “Rosiglitazone relieves acute ethanol-induced hangover in Sprague-Dawley rats,” Alcohol & Alcoholism, 41(3), pp. 231-235 (2006). This need for thiamine in the metabolism of acetaldehyde was found through the clinical trials of Jolliffe et al. See, Jolliffe, N., Quart J. Studies Alc., 1, 74 (1940); Jolliffe, N., Colbert, C. N., and Joffe, P. M., American Journal of Medical Science, 191, 515 (1936). During alcohol consumption thiamine is used up quickly, and without additional intake of the vitamin, the build up of acetaldehyde can be severe. When thiamine is deficient, symptoms such as lethargy, fatigue, apathy, impaired awareness, loss of equilibrium, disorientation, memory loss, anorexia, and muscular weakness can be observed. Severe cases of thiamine deficiency can result in death. This deficiency in thiamine from alcohol consumption has been associated with cerebellar degeneration. Allithiamines (such as Benfotiamine) can also be used to replenish the body's thiamine store and have been shown to be more bioavailable than thiamine. See, Kitamori, N. and Itokawa, Y., “Pharmacokinetics of thiamin after oral administration of thiamin tetrahydrofurfuryl disulfide to humans,” J. Nutr. Sci. Vitaminol, 39:465-472 (1993); Baker, H. and Frank, O., “Absorption, utilization and clinical effectiveness of allithiamines compared to water-soluble thiamines,” J. Nutr. Sci. Vitaminol, 22(suppl):63-68 (1976).

Thomson et al. found that 80% of hospital patients with Wernicke's Encephalopathy (WE) are not diagnosed prior to death. WE is a disease contributed to by thiamine deficiency often associated with alcoholism. Thomson, A. D. et al., “The treatment of patients at risk of developing Wernicke's encephalopathy in the community,” Alcohol & Alcoholism, 41:159-167 (2006). The strongest means of combating WE is through thiamine supplementation. It may also be necessary to supplement niacin (B₆) and folate (B₁₂) to ensure the effectiveness of the thiamine. Thomson et al. do not recommend the fortification of alcoholic beverages with thiamine.

It is also important that Weise et al., in reviewing hangovers, note there is no evidence suggesting that reduction or elimination of hangovers results in increased consumption. They also have found that hangovers occur predominantly (70%) in light to moderate drinkers with over 75% of all drinkers having experienced a hangover. Wiese, J. G., Shlipak, M. G., and Browner, W. S., “The Alcohol Hangover,” Annals of Internal Medicine, 132(11): 897-902 (2000).

While it has been recognized in the art that there is a need for nutrient fortification in beer, mainly thiamine in beer and other alcoholic beverages, the reduced bioavailability of thiamine when consumed with alcohol or by chronic alcohol abusers is not taken into account. See, for example, U.S. Pat. No. 2,273,853, U.S. patent Publications Nos. 2003-0157218 A1, 2005-0191386-A1 and 2006-075059-A1, Chinese Patent No. 1336424 and Korean Publication No. 20010069765.

Thus a need remains in the art to develop beer and other alcoholic formulations which are nutrient fortified in order to help counteract nutrient deficiencies that can be associated with alcoholism and/or hangovers, but which still provides a resulting beverage having palatable flavor, clarity and/or other properties desirable in such a beverage.

### BRIEF SUMMARY OF THE INVENTION

The invention includes an alcoholic beverage, comprising an alcoholic formulation and a vitamin selected from thiamine (B₁), allithiamine and combinations thereof, wherein the alcoholic beverage has greater than about 0.19 milligrams of the thiamine per gram of ethanol in the alcoholic beverage and/or greater than about 0.02 milligrams of the allithiamine per gram of ethanol in the alcoholic beverage.

In one embodiment of the alcoholic beverage, the alcoholic beverage comprises at least about 1.77 to about 3.55 mg of the thiamine per gram of ethanol in the alcoholic beverage and/or at least about 0.2 to about 0.41 mg of the allithiamine per gram of ethanol in the alcoholic beverage.

In a further embodiment of the alcoholic beverage, the alcoholic formulation is beer and the beverage comprises greater than about 7.5 mg/l to about 140 mg/l of thiamine (B₁).

In a further embodiment of the alcoholic beverage, the alcoholic formulation is wine and the beverage comprises greater than about 15 mg/l to about 300 mg/l of thiamine (B₁).

In yet further embodiments of the alcoholic beverage, the alcoholic formulation is a liquor formulation and the beverage comprises greater than about 60 to about 1000 mg/l of the thiamine (B₁). In another embodiment, the alcoholic beverage has an alcoholic formulation, which is a mixer formulation.

A beer beverage is also within the invention, comprising a beer formulation, a vitamin selected from thiamine (B₁), allithiamine and combinations thereof, and L-glutamine, wherein the beer beverage has greater than about 0.19 milligrams of the thiamine per gram of ethanol in the beer beverage and/or greater than about 0.02 milligrams of the allithiamine per gram of ethanol in the beer beverage.

The invention further includes a wine comprising a wine formulation, a vitamin selected from thiamine (B₁), allithiamine and combinations thereof, wherein the wine has greater than about 0.19 milligrams of the thiamine per gram of ethanol in the wine and/or greater than about 0.02 milligrams of the allithiamine per gram of ethanol in the wine, and folic acid (B₉).

A liquor is also within the invention comprising a liquor formulation, a vitamin selected from thiamine (B₁), allithiamine and combinations thereof, wherein the liquor has greater than about 0.19 milligrams of the thiamine per gram of ethanol in the liquor and/or greater than about 0.02 milligrams of the allithiamine per gram of ethanol in the liquor, and folic acid (B₉).

The invention includes further a mixer for mixing with a liquor to form a liquor beverage, comprising a mixer formulation, a vitamin selected from the thiamine (B₁), allithiamine and combinations thereof, wherein the mixer has a concentration of thiamine and/or allithiamine such that the liquor beverage has greater than about 0.19 milligrams of the thiamine per gram of ethanol in the liquor beverage and/or greater than about 0.02 milligrams of the aliithiamine per gram of ethanol in the liquor beverage, and folic acid (B₉).

A method is also included herein for preparing a nutrient-enhanced alcoholic beverage, comprising adding at least one nutrient selected from thiamine (B₁), allithiamine and combinations thereof to a bulk alcoholic beverage formulation during processing of the bulk alcoholic beverage formulation prior to a final filtration step to form a nutrient-enhanced alcoholic beverage.

In one embodiment of the method, the alcoholic beverage is a liquor, the bulk alcoholic beverage formulation is a bulk liquor formulation, and method further comprises pumping the nutrients into the bulk liquor formulation using a static mixer for blending the nutrients with the bulk liquor formulation, prior to dilution and final filtration of the bulk liquor formulation.

In another embodiment of the method, the alcoholic beverage is a liquor and the bulk alcoholic beverage formulation is a bulk liquor formulation, and the method further comprises blending the nutrients into a first portion of the bulk liquor formulation in a dosed buffer tank and/or a holding tank with an impeller, and then adding the blended first portion of the bulk liquor formulation and the nutrients to the bulk liquor formulation.

In a further embodiment of the method, the alcoholic beverage is a beer, the bulk alcoholic beverage formulation is a bulk beer formulation, and the method further comprises adding the nutrients in a slurry form and pumping the nutrient slurry into the bulk beer formulation.

In still a further embodiment of the method, the alcoholic beverage is a beer, the bulk alcoholic beverage formulation is a beer formulation, and the method further comprises blending a first portion of the bulk beer formulation with the nutrients in a dosing buffer tank and/or a holding tank having an impeller, and adding the blended first portion of the bulk beer formulation and the nutrients back into the bulk beer formulation.

The invention also includes a method for preparing a nutrient-enhanced wine, comprising mixing at least one nutrient selected from thiamine (B₁), allithiamine and combinations thereof to a bulk wine formulation during processing of the bulk wine formulation, wherein the nutrients are added in a slurry form, after aging and before bottling of the bulk wine formulation. In another embodiment of the method, the method further comprises blending a first portion of the bulk wine formulation with the nutrients in a dosing buffer tank and/or a holding tank having an impeller, and adding the blended first portion of the bulk wine formulation and the nutrients to the bulk wine formulation.

Also included herein is a method for preparing a nutrient-enhanced alcoholic mixer formulation, comprising adding at least one nutrient selected from thiamine (B₁), allithiamine and combinations thereof to a bulk alcoholic mixer formulation during processing of the bulk alcoholic mixer formulation prior to a final packaging step to form a nutrient-enhanced alcoholic mixer formulation.

### BRIEF DESCRIPTION OF THE SEVERAL VIEWS OF THE DRAWING(S)

The foregoing summary, as well as the following detailed description of preferred embodiments of the invention, will be better understood when read in conjunction with the appended drawings. For the purpose of illustrating the invention, there is shown in the drawings embodiments that are presently preferred. It should be understood, however, that the invention is not limited to the precise arrangements and instrumentalities shown. In the drawings:

FIG. 1 is a flow diagram showing a method for making beer according to an embodiment described herein in which nutrients are added in a slurry in-line through a static mixer to a bulk beer formulation;

FIG. 1A is a flow diagram of an alternative method to the method described in FIG. 1 in which nutrients are added in a dosed buffer tank prior to adding the nutrients back into the bulk beer formulation;

FIG. 1B is a flow diagram of an alternative method to the method described in FIG. 1 in which nutrients are added in a holding tank having an impeller prior to adding the blended nutrients back into the bulk beer formulation;

FIG. 2 is a flow diagram showing a method for making wine according to another embodiment described herein in which nutrients are added in slurry form post aging and pre-bottling as well as prior to an optional filtration step;

FIG. 2A is a flow diagram of an alternative method to the method described in FIG. 2 in which nutrients are added in a dosed buffer tank prior to adding the nutrients back into the bulk wine formulation;

FIG. 2B is a flow diagram of an alternative method to the method described in FIG. 2 in which nutrients are added in a holding tank having an impeller prior to adding the blended nutrients back into the bulk wine formulation;

FIG. 3 is a flow diagram showing a method for making liquor (spirits) according to another embodiment described herein in which nutrients are added in slurry form through a static mixer prior to filtration;

FIG. 3A is a flow diagram of an alternative method to the method described in FIG. 3 in which nutrients are added in a dosed buffer tank prior to adding the nutrients back into the bulk liquor formulation;

FIG. 3B is a flow diagram of an alternative method to the method described in FIG. 3 in which the nutrients are added in a holding tank having an impeller prior to adding the blended nutrients back into the bulk liquor formulation;

FIG. 4 is a flow diagram of a standard beer making method according to the prior art;

FIG. 5 is a flow diagram of a standard wine making method according to the prior art; and

FIG. 6 is a flow diagram of a standard liquor making method according to the prior art.

### DETAILED DESCRIPTION OF THE INVENTION

The formulations of the alcoholic beverages herein are designed to supply nutrients that are generally deficient as a result of alcohol consumption. Consumers of the beverages should note a decrease in hangover symptoms ordinarily experienced with non-fortified alcoholic beverages.

In order to compensate for the reduced bioavailability of thiamine during alcohol consumption the present formulation has increased the level of thiamine and/or used its fat-soluble derivative, allithiamines, to allow for as low as a 10% bioavailability and a 50% bioavailability respectively. Thiamine is known in the art as a water-soluble B-complex vitamin, also known as vitamin B₁ or aneurine. Thiamine typically has the following molecular structure in Formula (I):

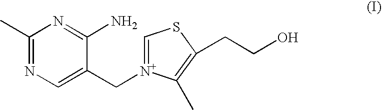

Allithiamine is an alkyl thiamine disulfide compound. As used herein, “thiamine” includes all thiamine compounds that may be metabolized and/or ingested by humans, including various thiamine derivatives such as thiamine hydrochloride. As used herein, “allithiamine” includes various lipid soluble thiamine alkyl disulfides, including but not limited to thiamine tetrahydrofurfuryl disulfide (TTFD), thiamine propyl disulfide (TPD) and O-benzoylthiamine disulfide.

Because there is very little thiamine stored in the body, depletion can occur as quickly as within 14 days. Severe chronic thiamine deficiency (beriberi) can result in potentially serious complications involving the nervous system/brain, muscles, heart, and gastrointestinal system. Also as used herein, “nutrient” is used broadly to encompass thiamine, various vitamins and nutrient additives described herein.

Dietary sources of thiamine include beef, Brewer's yeast, legumes (beans, lentils), milk, nuts, oats, oranges, pork, rice, seeds, wheat, whole grain cereals, and yeast. In industrialized countries, foods made with white rice and white flour may be fortified with thiamine (because most of the naturally occurring thiamine is lost during the refinement process). As used herein, the thiamine and/or allithiamine in the alcoholic beverage formulations may be from any suitable thiamine source capable of providing thiamine as described herein for human ingestion and which is capable of being incorporated into an alcoholic beverage formulation. One suitable source of thiamine is a thiamine hydrochloride compound available from AIE Pharmaceuticals, Ontario, Calif.

In the present invention, the quantities of thiamine added are based on amounts clinically recommended for detoxification in alcoholic patients and on the level of alcohol contained in the drink. See, for example, Markowitz, J. S., McRae, A. L., and Sonne, S. C., “Oral nutritional supplementation for the alcoholic patient: A brief overview,” Annals of Clinical Psychiatry, 12: 153-158 (2000). At higher levels of alcohol (as in spirits) allithiamines may be used within the invention to decrease the total amount of required nutrient to be added. The use of thiamine at the preferred concentrations herein greatly reduces the risk of Wernicke-Korsakoff syndrome and other alcohol-related illnesses as well as alleviates or lessens the resultant hangover associated with alcohol consumption.

Additional B-vitamins may be added as appropriate but are optional in some of the alcoholic beverages herein, such as beer, since most beer contains other B-vitamins in sufficient concentrations. For example, folic acid, vitamin B₉, may be added to help increase the bioavailability of thiamine, thereby decreasing the amount of requisite thiamine to be used in the formulation.

The preferred concentration of thiamine used in each formulation is preferably based on alcohol-related physiological harm from ingestion occurring at roughly 30 g of alcohol per day, as well as the starting concentration of naturally occurring nutrients in the product. For example, a 5 volume percent (% v/v) drink (a typical ethanol concentration for beer) contains approximately 14 g of alcohol. Therefore, the amount calculated to achieve a protective level of the nutrient will be dosed over the 30 g of alcohol equivalent. For example, if 2 beers provide 30 g (approximately) of alcohol and thiamine is determined to be protective at 50 mg for 30 g of alcohol, then 25 mg is the target concentration for each bottle of beer. In this way, each time a detrimental level of alcohol is consumed (i.e., 30 g), a protective level of nutrients is also consumed. The concentration of this blend can also take into account the reduced bioavailability of nutrients during alcohol consumption.

This concentration may also be applied to wine, spirits, and “mixers” (formulations in liquid or powder form whose intent is to be mixed with an alcoholic beverage or spirits to form a more palatable or enjoyable drink). In each case, the requisite amount of nutrients added is based on the alcohol content of the final drink, the desired flavor impact (or lack thereof) and the desired clarity. It should be noted that wine, spirits and other mixers have either a lower concentration of B-vitamins than beer does or none at all. For instance, spirits do not contain B-vitamins. Therefore, a more complete formulation is preferred for these beverages.

Ingredients are preferably added according to the methods described herein post-fermentation or post-distillation to avoid loss due to yeast uptake of nutrients or loss in subsequent filtration steps. A most preferred point of addition for alcoholic beverages requiring clarity is at post-primary filtration and prior to final “polish” filtration, which is for removal of any impurities or insoluble matter. If clarity is not critical (as is the case in many mixers), the nutrients may be added prior to packaging so long as any particulate matter remains in suspension or the consumer is advised to shake the contents of the mixer before using.

Ingredients and Their Usage:

As discussed above, thiamine is believed to be critical in the metabolism of ethanol, through acetaldehyde to carbon dioxide and water. With a deficiency of thiamine, acetaldehyde builds up and may be a leading cause of hangover symptoms. Accordingly, thiamine and/or allithiamine are required for use in the formulations herein. Thiamine and allithiamine may be used in combination. Thiamine may also be used exclusive of allithiamine. Allithiamine may be used as a substitute for thiamine.

Glutathione may also be employed by the liver to bind with toxins for excretion through bile or liver. Excessive alcohol ingestion depletes the glutathione store and can lead to toxin buildup and hangovers. N-acetylcysteine is an antioxidant that has been shown to help restore glutathione. Glutathione is thus an optional, but not required component in the formulations herein.

L-glutamine, while optional, is preferably used in the formulations to diminish the desire to drink, decrease anxiety, and improve sleep. While it reduces physical craving, it should not affect the desire to consume alcohol in a social setting for light to moderate drinkers. L-glutamine also helps to maintain cell volume and cell hydration.

Various other nutrients are also optionally added to the alcoholic beverages herein. For example, calcium may also be depleted by drinking alcoholic beverages. Domestic beer contains approximately 18 mg of calcium per 12 oz. bottle. However additional amounts may be provided for calcium enrichment. Magnesium may also be depleted by drinking alcoholic beverages. Depletion may result in symptoms of delirium tremens. Domestic beer contains approximately 21 mg magnesium per 12 oz. bottle. As with calcium, magnesium can be provided to help optionally counteract these results and for magnesium enrichment.

Selenium is likely a nutrient that may be depleted by alcohol consumption. Selenium is also needed for activity of glutathione, which may be important for the reasons noted above. As a result, selenium is an optional component for the alcoholic beverages described herein, particularly when glutathione is also used.

Zinc also may be depleted through alcohol consumption. Such depletion impairs ethanol metabolism. Thus, zinc is also recommended as an optional component for the formulations herein.

Depletion of folic acid (vitamin B₉) through alcohol consumption can lead to anemia. As a result, folic acid is a further optional component for alcoholic beverages described herein.

While, riboflavin deficiency can lead to behavioral changes and peripheral neuropathy, riboflavin is generally not a recommended addition to alcoholic products due to its known photooxidative properties and the resulting flavor-active compounds. Riboflavin is already present in beer naturally, however, additional riboflavin is not recommended due to the photooxidative properties.

Pyridoxine (B₆) deficiency can lead to behavioral changes, neurological disorders, peripheral neuropathy, and dermatological disorders. Deficiency in vitamin B₁₂ (available as cyanocobalamin) can lead to irritability, confusion, depression, disorientation, and psychosis. Deficiency of vitamin B₃ (niacin) deficiency can cause Pellagra, which is exhibited by dermatologic, central nervous system, and gastro-intestinal disorders. Pantothenic acid (B₅) may also be depleted with resulting deficiencies due to alcoholic consumption. As a result, these other B vitamins are also recommended as optional components in the formulations herein.

Formulations:

In order to combat the effects of alcohol on the above-noted deficiencies, the alcoholic beverage formulations herein differ from standard, prior art formulations through the addition of thiamine as a required component. Preferably the beverages herein include thiamine and/or allithiamine in the final beverage at a ratio of milligrams of thiamine and/or mg of allithiamine to grams of ethanol in the final beverage of greater than about 0.19 mg thiamine/g ethanol and/or greater than about 0.02 mg allithiamine/g ethanol, and more preferably at least about 1.77 to about 3.55 mg thiamine/g ethanol and/or at least about 0.2 to about 0.41 mg allithiamine/g ethanol. Such ratios are calculated based on ethanol density and content. For example, for a 5% by volume alcohol content beer (in a typical 355 ml size), there are about 17.75 ml of ethanol, wherein the ethanol density is 0.789 g/ml providing 14 g of ethanol per 355 ml beer beverage. The basic ratio of mg thiamine/g ethanol for the thiamine and/or allithiamine should remain the same for all of the alcoholic beverages according to the invention.

The formulation may also include one or more of the additional and optional components listed along with thiamine (B₁) and/or allithiamine in Tables 1-4. Table 1 represents preferred components and preferred compositions used for a beer formulation. All preferred minimum, maximum and most preferred values referred to herein, including in Tables 1-4, should be presumed to be approximately or about the amount stated, with the understanding that minor variations in the amounts would be within the scope of the invention. If allithiamine is used in the alcoholic beverages herein, however, it may be an optional, additional ingredient in the formulation or a substitute for the required thiamine (B₁) component. The contents in the Table are based on milligrams of component per liter of beverage and not based only on alcohol content.

TABLE 1

| | | Example | |
|---|---|---|---|
| | Minimum | Content | Maximum |
| Nutrient | (mg/l) | (mg/l) | (mg/l) |
| Thiamine (B₁) | >7.5 | 70.0 | 140.0 |
| L-Glutamine | 0.0 | 705.0 | 1000.0 |
| Folic Acid (B₉) | 0.0 | 1.4 | 2.8 |
| Pyridoxine (B₆) | 0.0 | 1.4 | 2.8 |
| Cyanocobalamin | 0.0 | 8.5 | 17.0 |
| (B₁₂) | | | |
| Niacin (B₃) | 0.0 | 14.1 | 28.2 |
| Pantothenic Acid | 0.0 | 1.9 | 4.0 |
| (B₅) | | | |
| Allithiamine* | >0.8 | 8.0 | 16.0 |
| Magnesium | 0.0 | 0.0 | 250 |
| Calcium | 0.0 | 0.0 | 250 |
| Glutathione | 0.0 | 0.0 | 250 |
| Selenium | 0.0 | 0.0 | 0.25 |
| Zinc | 0.0 | 0.0 | 250 |

*Can replace thiamine if used

Table 2 below shows similar recommended optional components to be used with thiamine as a required ingredient in a wine formulation. As with the proposed beer components listed above, allithiamine may be used as an optional additional ingredient to thiamine or as a substitute for the primary thiamine component. The remaining components may be used as optional nutritional components.

TABLE 2

| | | Example | |
|---|---|---|---|
| | Minimum | Content | Maximum |
| Nutrient | (mg/l) | (mg/l) | (mg/l) |
| Thiamine (B₁) | >15.0 | 165.0 | 300.0 |
| L-Glutamine | 0.0 | 1640.0 | 2000.0 |
| Folic Acid (B₉) | 0.0 | 3.3 | 7.0 |
| Pyridoxine (B₆) | 0.0 | 3.3 | 18.0 |
| Cyanocobalamin | 0.0 | 20.0 | 40.0 |
| (B₁₂) | | | |
| Niacin (B₃) | 0.0 | 33.0 | 66.0 |
| Pantothenic Acid | 0.0 | 4.7 | 9.5 |
| (B₅) | | | |
| Allithiamine* | >1.5 | 15.0 | 30.0 |
| Magnesium | 0.0 | 0.0 | 250 |
| Calcium | 0.0 | 0.0 | 250 |
| Glutathione | 0.0 | 0.0 | 250 |
| Selenium | 0.0 | 0.0 | 0.25 |
| Zinc | 0.0 | 0.0 | 250 |

*Can replace thiamine if used

Table 3 includes a formulation for liquor (spirits). As with Tables 1 and 2 above, allithiamine, can either be an optional component for use in addition to the required thiamine component or as a substitute therefor. The remaining components are recommended, optional components.

TABLE 3

| | | Example | |
|---|---|---|---|
| | Minimum | Content | Maximum |
| Nutrient | (mg/l) | (mg/l) | (mg/l) |
| Thiamine (B₁) | >60.0 | 526.0 | 1000.0 |
| Folic Acid (B₉) | 0.0 | 10.5 | 20.0 |
| Pyridoxine (B₆) | 0.0 | 10.5 | 20.0 |
| Cyanocobalamin | 0.0 | 6.8 | 12.5 |
| (B₁₂) | | | |
| Niacin (B₃) | 0.0 | 105.0 | 200.0 |
| Pantothenic Acid | 0.0 | 15.0 | 30.0 |
| (B₅) | | | |
| Allithiamine* | >6.0 | 60.0 | 120.0 |
| Magnesium | 0.0 | 0.0 | 250 |
| Calcium | 0.0 | 0.0 | 250 |
| Glutathione | 0.0 | 0.0 | 250 |
| Selenium | 0.0 | 0.0 | 0.25 |
| Zinc | 0.0 | 0.0 | 250 |

*Can replace thiamine if used

Table 4 below provides suggested minimum, maximum and preferred concentrations of ingredients for mixer formulations, such as sour mix, margarita mix, bloody Mary mix and the like. The components listed are provided in mg/l concentrations for use in exemplary mixer formulations in which 4 parts mixer is added to 3 parts liquor/spirits, wherein the liquor is 80 proof (40% alcohol). It should be understood, based on this disclosure, that other similar formulations could be made up for other mixer/spirit combinations, e.g., a 3:1 mixer to liquor combination, etc., without departing from the scope of the invention and using the guidelines for the preferred concentration of each preferred component per gram of ethanol in the final beverage as provided herein for the various beverage formulations, but recalculating the mg/l concentration based on the particular beverage and mixer/spirit ratio.

TABLE 4

| | | Example | |
|---|---|---|---|
| | Minimum | Content | Maximum |
| Nutrient | (mg/l) | (mg/l) | (mg/l) |
| Thiamine (B₁) | >25.7 | 225.4 | 428.6 |
| Folic Acid (B₉) | 0.0 | 4.5 | 8.6 |
| Pyridoxine (B₆) | 0.0 | 4.5 | 8.6 |
| Cyanocobalamin | 0.0 | 29.1 | 53.6 |
| (B₁₂) | | | |
| Niacin (B₃) | 0.0 | 45.0 | 85.7 |
| Pantothenic Acid | 0.0 | 6.4 | 12.9 |
| (B₅) | | | |
| Allithiamine* | >2.6 | 25.7 | 51.4 |
| Magnesium | 0.0 | 0.0 | 250 |
| Calcium | 0.0 | 0.0 | 250 |
| Glutathione | 0.0 | 0.0 | 250 |
| Selenium | 0.0 | 0.0 | 0.25 |
| Zinc | 0.0 | 0.0 | 250 |

*Can replace thiamine if used

Preferred ingredients in the various example formulations noted above include L-glutamine, folic acid (B₉), pyridoxine (B₆), cyanocobalamin (B₁₂), niacin (B₃) and pantothenic acid (B₅), each of which has preferred concentrations in each formulation in terms of the ratio of mg nutrient/g ethanol in the final beverage of about 17.87 to about 25.36 mg L-glutamine/g ethanol; about 0.035 to about 0.071 mg folic acid/g ethanol; about 0.035 to about 0.071 mg pyridoxine/g ethanol; 0.216 to about 0.431 mg cyanocobalamin/g ethanol; 0.357 to about 0.715 mg niacin/g ethanol; and 0.048 to about 0.101 mg pantothenic acid/g ethanol.

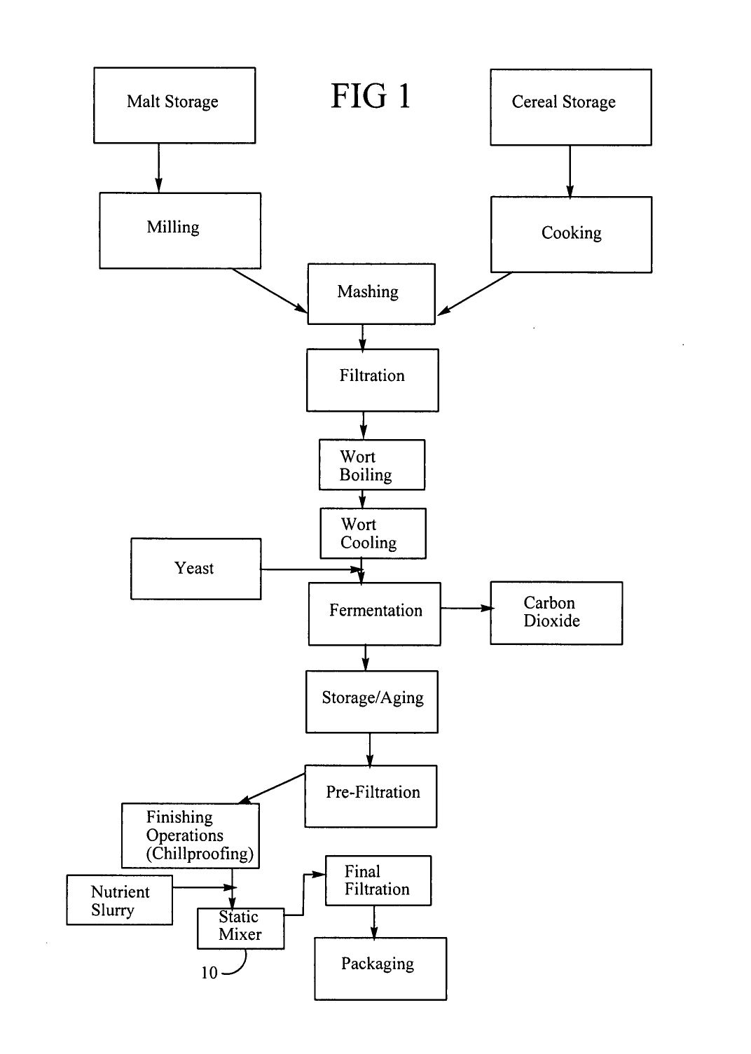

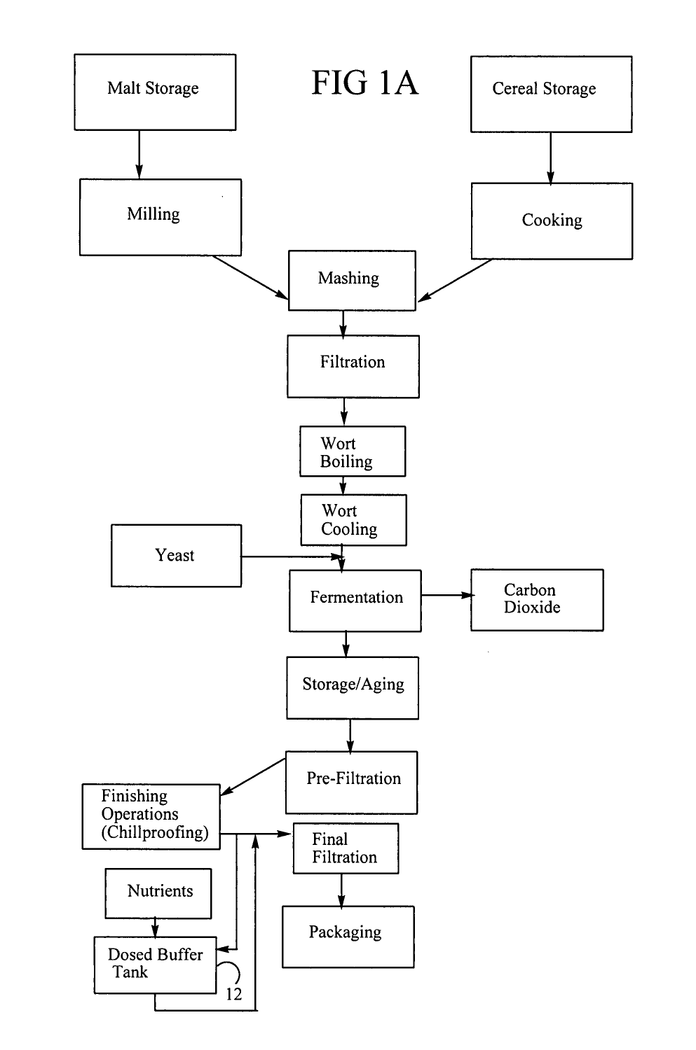

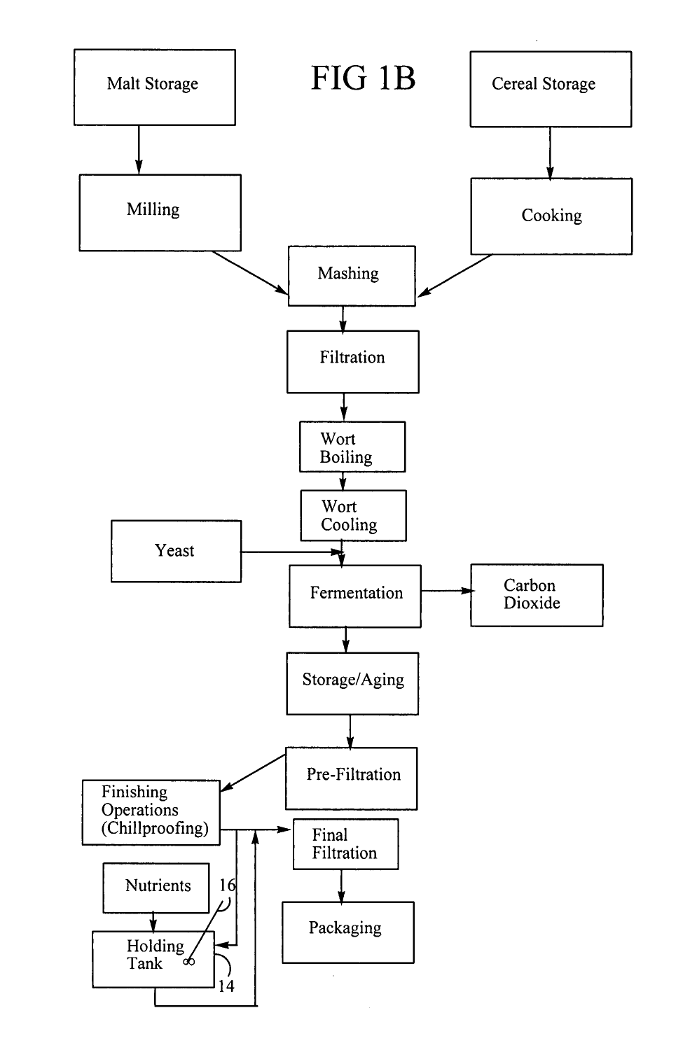

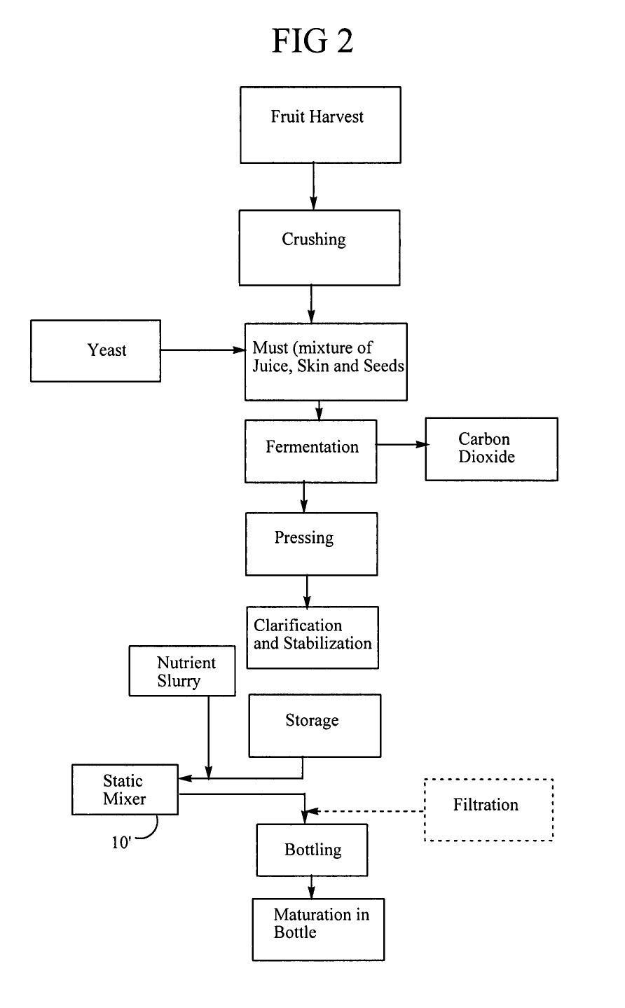

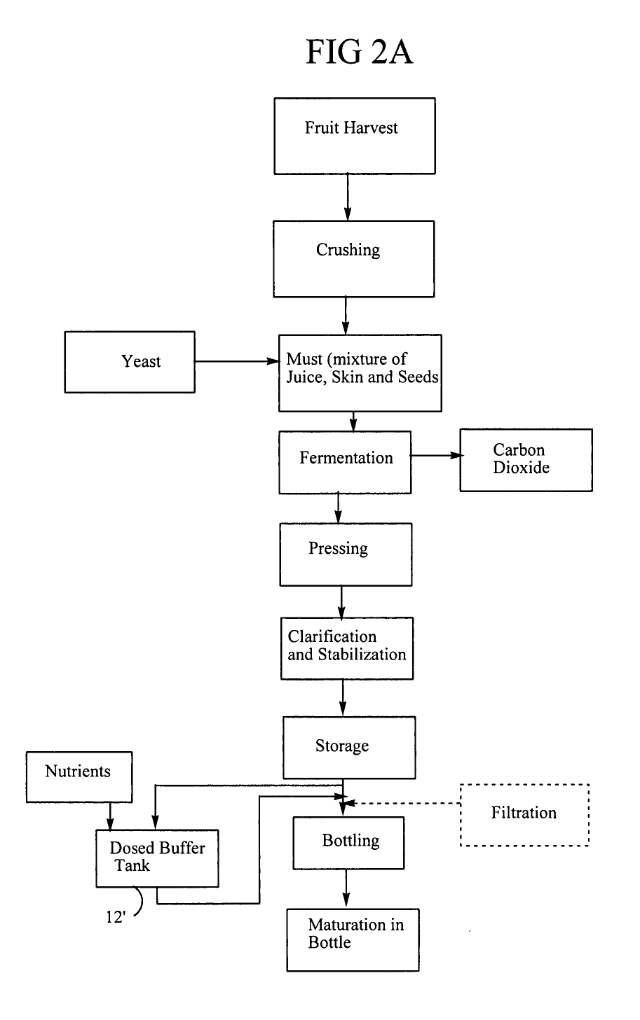

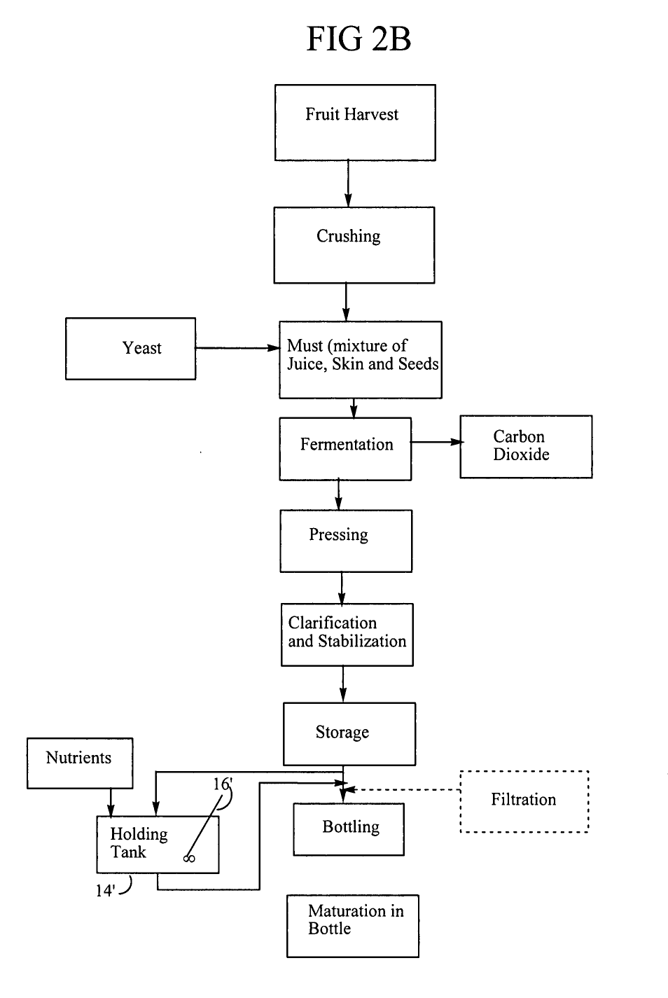

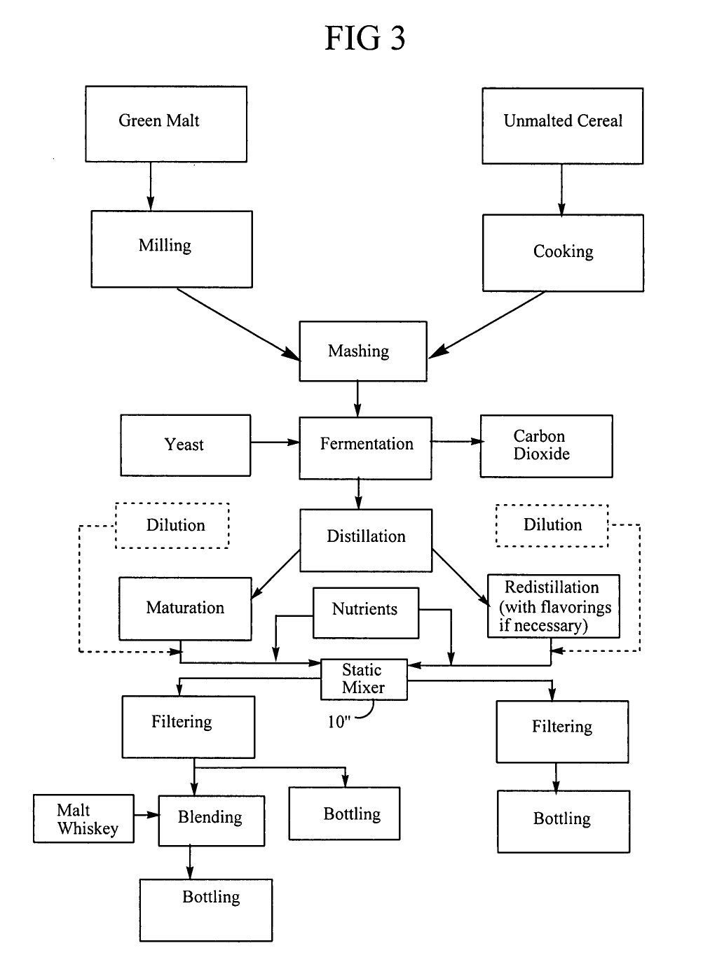

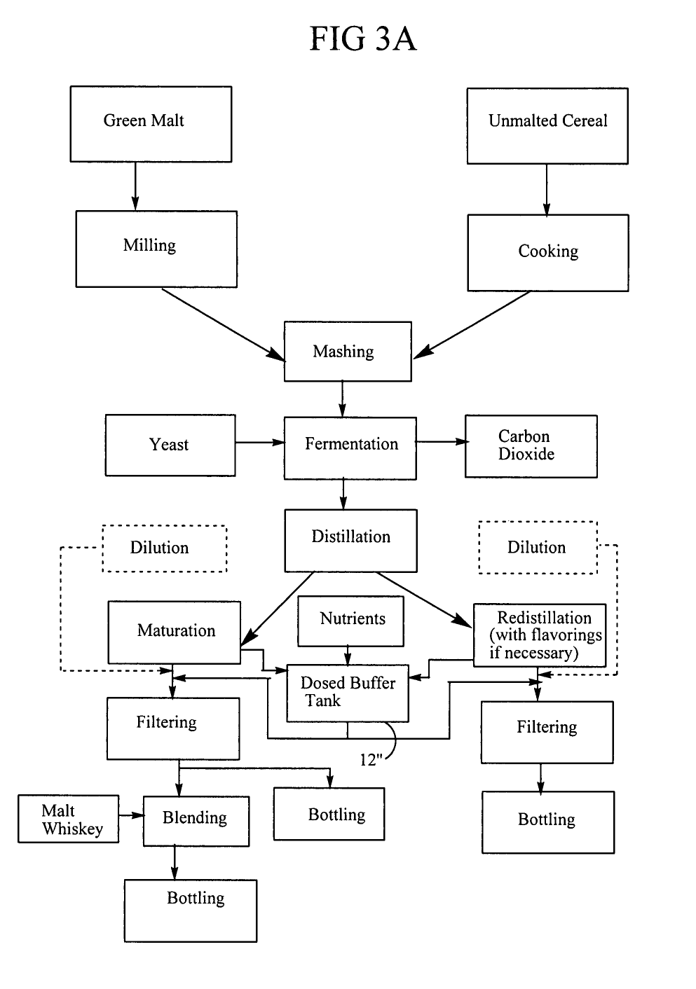

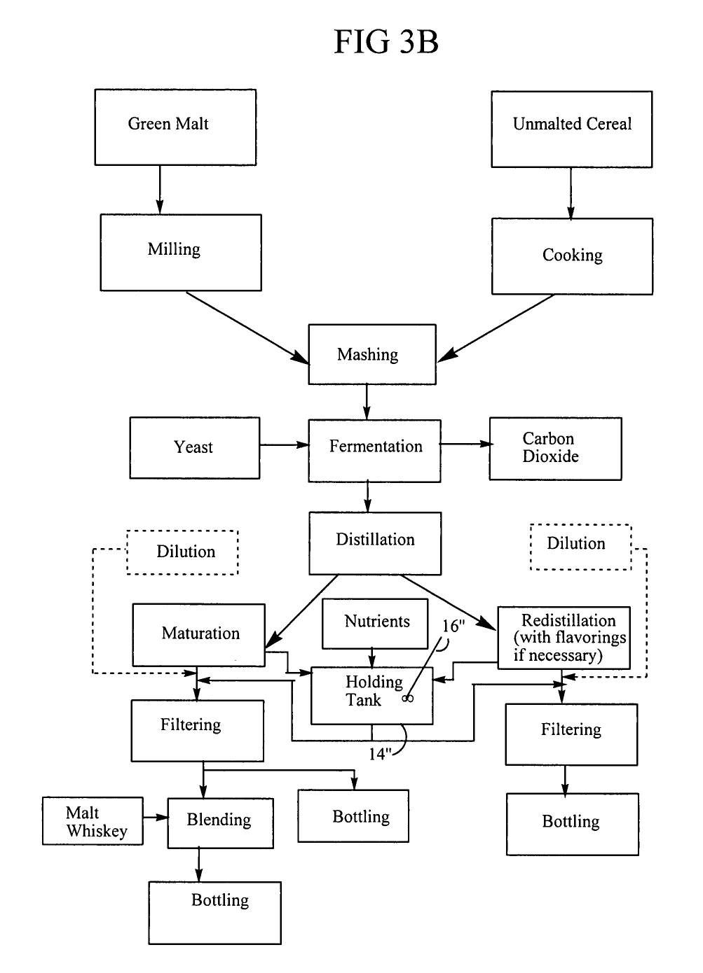

The ingredients noted above in Tables 1-4 may be supplied in liquid or powder form, and can be added as a slurry, as a powder, or blended with diatomaceous earth. When added as a slurry, the liquid in the slurry may be either a portion of the liquor formulation or water. In one embodiment of the method herein, the slurry may be added in-line, preferably using optional in-line mixing apparatuses such as static mixers. As shown in FIGS. 1, 2 and 3, a static mixer 10, 10′, 10″ (or similar apparatus) may be placed so as to be inline with a portion of an alcoholic beverage making method according to the invention and positioned so as to introduce a slurry directly into the bulk alcoholic beverage at various stages of the process as shown, depending upon the nature of that process being a beer (FIG. 1), wine (FIG. 2) or spirits method (FIG. 3).

Alternatively, according to another embodiment of the method herein as shown in FIGS. 1A, FIG. 2A, FIG. 3A, the nutrients may be added to a dosed buffer tank 12, 12′, 12″, where it is first blended with a portion of the bulk alcoholic beverage. As used herein, the buffer tank is a process buffer in which a fraction of the total product is stored in a tank and dosed with a fraction of a nutrient slurry. The tank is continuously filled and drained. After blending, the nutrient and blended portion of the bulk alcoholic beverage are added back into the primary process flow. When dosing in-line or through a closed buffer tank, dosing should occur over approximately 90 percent of the total batch volume.

Similarly as shown in FIGS. 1B, 2B and 3B, a holding tank 14, 14′, 14″ may be used preferably equipped with an impeller 16, 16′, 16″ or other mixing apparatus. As with a dosing tanks and/or holding tanks with mixing apparatus, it is preferred that at least a first portion of the bulk alcoholic beverage formulation is first separated from the bulk formulation during processing and then combined with the nutrients. After blending, the first portion of the bulk alcoholic beverage formulation with the nutrients blended therein is added back into the bulk alcoholic beverage formulation in the main processing apparatus.

Mixing apparatuses used herein may be impellers, agitators, mixers or similar blending devices. As used herein, “blending” includes blending, mixing, folding, agitating, beating, shaking or other method of combination of solids and/or liquids to form a substantially uniform blend. Preferred methods for addition of the components are noted below.

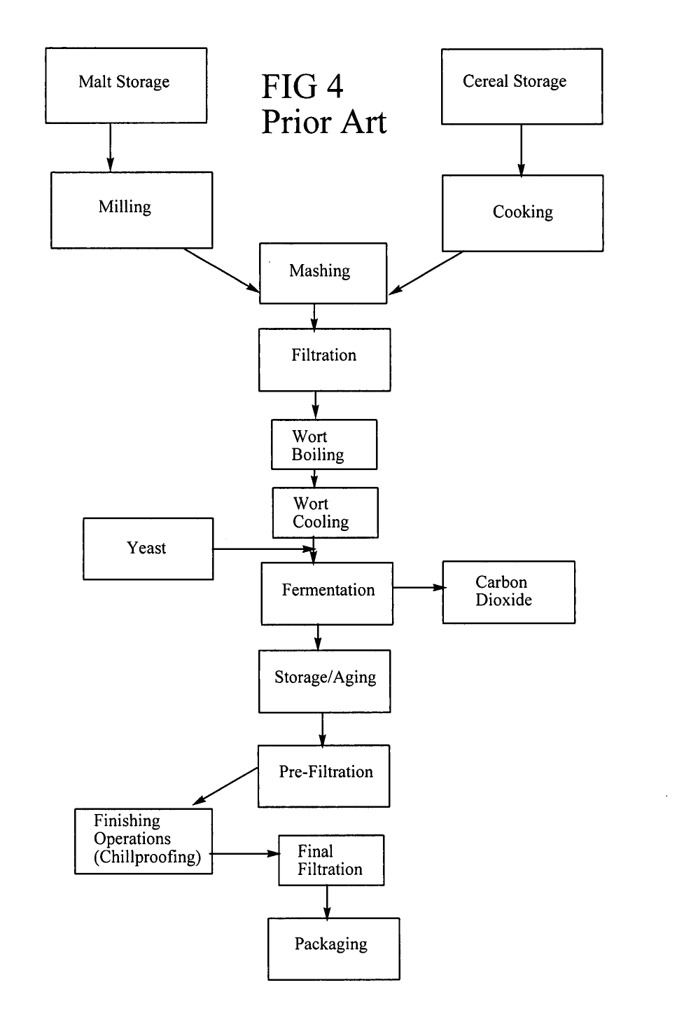

Beer brewing is performed in accordance with standard good manufacturing practice (GMP) and follows, but is not limited to, the exemplary basic process outlined in FIG. 4. In the preferred method for providing the components in the noted amounts herein, the nutrients are introduced between pre-filtration and final filtration as shown in FIGS. 1, 1A and 1B.

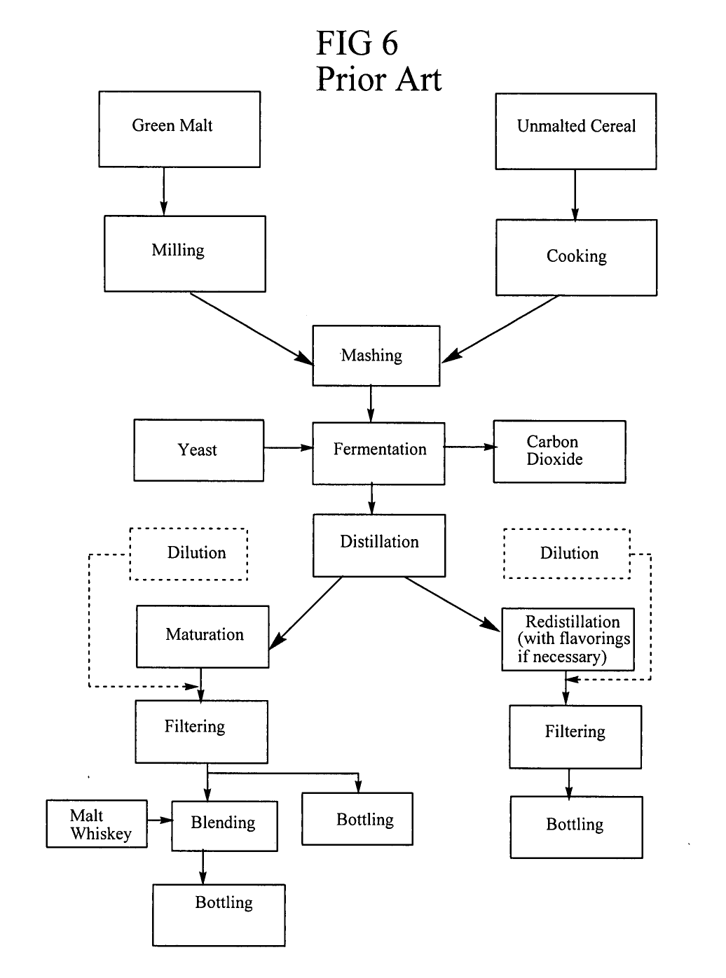

An exemplary, general GMP method for liquor/spirits manufacture follows, but is not limited to, the exemplary process outlined in FIG. 6. In a preferred method here, the nutrients are introduced prior to filtration of the aged spirit (if aging is appropriate) or prior to filtration if fresh distillate is used as shown in FIGS. 3, 3A and 3B.

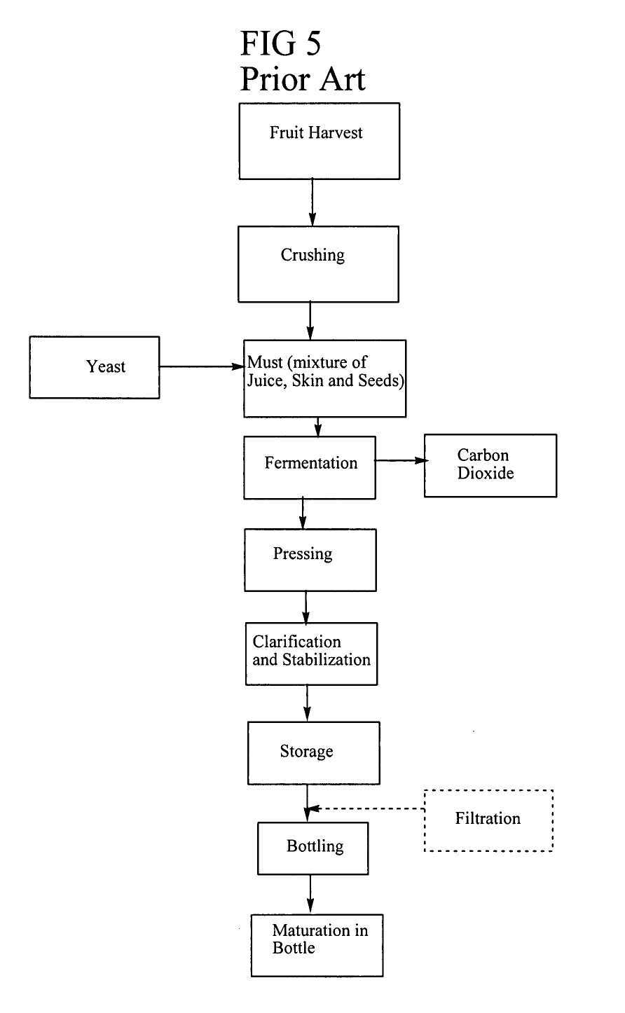

Similarly, an example of a GMP process for wine manufacture herein follows, but is not limited to, the exemplary process outlined in FIG. 5. In a preferred method according to the invention, nutrients are introduced after storage and before bottling as shown in FIGS. 2, 2A and 2B.

A mixer formulation according to the invention may be prepared in which the required and optional nutrients recommended herein are provided to the mixer formulation using any of the mixing techniques described herein for the other alcoholic beverages as part of the standard mixer formulation process prior to packaging the mixer.

The invention will now be described in accordance with the following non-limiting examples:

### EXAMPLE 1

A typical beer having an existing B-vitamin concentration in 355 ml (12 fl. oz.) is to be used. Such a typical beer has the following B-vitamin concentration:

4.6 mg niacin (B₃)

1.9 mg pantothenic acid

3.3 mg thiamine

1.4 mg pyrodoxine (B₆)

1.47 mg folic acid (B₉)

4.1 mg cyanocobalamin (B₁₂)

1.54 mg riboflavin

Note that the riboflavin noted above is naturally occurring in a standard beer formulation and so would be present, but would not be the subject of an additional component provided to the beer formulation. The following components are added to the beer according to the invention described herein:

25 mg of thiamine

250 mg of L-glutamine

As shown in FIG. 1, the nutrient ingredients are added as a slurry, which is pumped into the beer line followed by a static mixer 10 prior to a final filtration step. In an alternate method example as shown in FIG. 1A, a dosed buffer tank 12 is used in which the product is blended with the nutrient ingredients and is then dosed back into the bulk product, or as shown in FIG. 1B, into a holding tank 14 with an impeller 16 where the above ingredients are added and mixed.

### EXAMPLE 2

In 100 ml of wine (12.5% alcohol by volume), the following nutrient ingredients are added:

16.4 mg thiamine

0.33 mg folic acid (B₉)

0.33 mg pyridoxine (B₆)

164 mg L-glutamine

As shown in FIG. 2, the nutrient ingredients are added as a slurry using an in-line static mixer 10′, post-aging and pre-bottling with an effective level of mixing, and before a filtration step if filtration is used in the wine making process. In an alternate example method as shown in FIG. 2A, the nutrient ingredients are added to a dosed buffer tank 12′ where product is blended and then dosed back into the bulk product. Alternatively, as shown in FIG. 2B, the nutrients are added and mixed with bulk product in a holding tank 14′ with an impeller 16′.

### EXAMPLE 3

For 1 L of standard “white” rum, assuming no B-vitamins present, the following nutrients are added:

526 mg thiamine

10.5 mg folic acid (B₉)

10.5 mg pyridoxine (B₆)

133.5 mg niacin (B₃)

As shown in FIG. 3, these ingredients are pumped into the liquor line with a static mixer 10″ for blending, post-dilution, and prior to final filtration. In an alternative example as shown in FIG. 3A, the nutrients are blended in a dosed buffer tank 12″ with product and then dosed back into the bulk product. FIG. 3B shows a further alternative in which the nutrients are added to a holding tank 14″ with product and an impeller 16″ and mixed.

### EXAMPLE 4

A mixer designed for use with 4 parts mixer to 3 parts of 80 proof alcoholic spirits (i.e., 40% ethanol) is prepared in this Example. To the mixer formulation, the following components are added:

225 mg/l thiamine

4.5 mg/l folic acid (B₉)

4.5 mg/l pyridoxine (B₆)

29.1 mg/l cyanocobalamin (B₁₂)

45 mg/l niacin (B₃)

6.4 mg/l pantothenic acid

25.7 mg/l allithiamine

The components listed above are added to a mixing tank including a standard spirits mixer formulation in the above noted concentrations and mixed therein prior to packaging of the mixer formulation.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

I claim:

1. An alcoholic beverage, comprising
an alcoholic formulation and
a vitamin selected from thiamine (B₁), allithiamine and combinations thereof,
wherein the alcoholic beverage has greater than about 0.19 milligrams of the thiamine per gram of ethanol in the alcoholic beverage and/or greater than about 0.02 milligrams of the allithiamine per gram of ethanol in the alcoholic beverage.

2. The alcoholic beverage according to claim 1, comprising at least about 1.77 to about 3.55 mg of the thiamine per gram of ethanol in the alcoholic beverage and/or at least about 0.2 to about 0.41 mg of the allithiamine per gram of ethanol in the alcoholic beverage.

3. The alcoholic beverage according to claim 1, wherein the alcoholic formulation is beer.

4. The alcoholic beverage according to claim 3, wherein the beverage comprises greater than about 7.5 mg/l to about 140 mg/l of thiamine (B₁).

5. The alcoholic beverage according to claim 4, comprising about 70 mg/l to about 140 mg/l of thiamine (B₁).

6. The alcoholic beverage according to claim 3, wherein the beverage comprises allithiamine.

7. The alcoholic beverage according to claim 6, comprising greater than about 0.8 mg/l to about 16 mg/l of allithiamine.

8. The alcoholic beverage according to claim 7, comprising about 8 mg/l to about 16 mg/l of allithiamine.

9. The alcoholic beverage according to claim 3, further comprising L-glutamine.

10. The alcoholic beverage according to claim 9, comprising up to about 1000 mg/l of L-glutamine.

11. The alcoholic beverage according to claim 10, comprising about 705 mg/l to about 1000 mg/l of L-glutamine.

12. The alcoholic beverage according to claim 3, further comprising a component selected from the group consisting of folic acid (B₉), pyridoxine (B₆), cyanocobalamin (B₁₂), niacin (B₃), pantothenic acid (B₅), magnesium, calcium, glutathione, selenium, zinc and combinations thereof.

13. The alcoholic beverage according to claim 1, wherein the alcoholic formulation is wine.

14. The alcoholic beverage according to claim 13, comprising greater than about 15 mg/l to about 300 mg/l of thiamine (B₁).

15. The alcoholic beverage according to claim 14, comprising about 165 mg/l to about 300 mg/l of thiamine (B₁).

16. The alcoholic beverage according to claim 13, further comprising L-glutamine, folic acid, pyridoxine (B₆), and niacin.

17. The alcoholic beverage according to claim 16, comprising up to about 2000 mg/l of the L-glutamine, up to about 7 mg/l of the folic acid (B₉), up to about 18 mg/l of the pyridoxine (B₆), up to about 66 mg/l of the niacin (B₃).

18. The alcoholic beverage according to claim 17, comprising about 1640 to about 2000 mg/l of the L-glutamine, about 3.3 to about 7 mg/l of the folic acid (B₉), about 3.3 to about 18 mg/l of the pyridoxine (B₆), about 33 mg/l to about 66 mg/l of the niacin (B₃).

19. The alcoholic beverage according to claim 13, comprising greater than about 1.5 mg/l to about 30 mg/l of allithiamine.

20. The alcoholic beverage according to claim 13, further comprising a component selected from the group consisting of L-glutamine, folic acid (B₉), pyridoxine (B₆), cyanocobalamin (B₁₂), niacin (B₃), pantothenic acid (B₅), magnesium, calcium, glutathione, selenium, zinc and combinations thereof.

21. The alcoholic beverage according to claim 1, wherein the alcoholic formulation is a liquor formulation.

22. The alcoholic beverage according to claim 21, comprising greater than about 60 to about 1000 mg/l of the thiamine (B₁) and/or greater than about 6 to about 120 mg/l of the allithiamine.

23. The alcoholic beverage according to claim 22, comprising about 526 to about 1000 mg/l of the thiamine (B₁) and/or about 60 to about 120 mg/l of the allithiamine.

24. The alcoholic beverage according to claim 21, further comprising folic acid (B₉), pyridoxine (B₆), and niacin (B₃).

25. The alcoholic beverage according to claim 24, further comprising about 10.5 mg/l to about 20 mg/l of the folic acid (B₉), about 10.5 mg/l to about 20 mg/l of the pyridoxine (B₆), and about 105 mg/l to about 200 mg/l niacin (B₃).

26. The alcoholic beverage according to claim 21, further comprising a component selected from the group consisting of folic acid (B₉), pyridoxine (B₆), cyanocobalamin (B₁₂), niacin (B₃), pantothenic acid (B₅), magnesium, calcium, glutathione, selenium, zinc and combinations thereof.

27. The alcoholic beverage according to claim 1, wherein the alcoholic formulation is a mixer formulation.

28. A beer beverage, comprising
a beer formulation,
a vitamin selected from thiamine (B₁), allithiamine and combinations thereof, and
L-glutamine, wherein the beer beverage has greater than about 0.19 milligrams of the thiamine per gram of ethanol in the beer beverage and/or greater than about 0.02 milligrams of the allithiamine per gram of ethanol in the beer beverage.

29. The beer beverage according to claim 28, wherein the beer beverage comprises 355 ml of the beer formulation, 25 mg of the thiamine and 250 mg of the L-glutamine.

30. A wine comprising:
a wine formulation,
a vitamin selected from thiamine (B₁), allithiamine and combinations thereof,
wherein the wine has greater than about 0.19 milligrams of the thiamine per gram of ethanol in the wine and/or greater than about 0.02 milligrams of the allithiamine per gram of ethanol in the wine, and
folic acid (B₉).

31. The wine according to claim 30, further comprising pyridoxine (B₆) and L-glutamine.

32. The wine according to claim 31, comprising 100 ml of the wine formulation, wherein the wine formulation is about 12.5% alcohol by volume, about 16.4 mg thiamine, 0.33 mg folic acid (B₉), about 0.33 mg pyridoxine (B₆) and about 164 mg L-glutamine

33. A liquor, comprising
a liquor formulation,
a vitamin selected from thiamine (B₁), allithiamine and combinations thereof,
wherein the liquor has greater than about 0.19 milligrams of the thiamine per gram of ethanol in the liquor and/or greater than about 0.02 milligrams of the allithiamine per gram of ethanol in the liquor, and
folic acid (B₉).

34. The liquor according to claim 33, further comprising pyridoxine (B₆) and niacin (B₃).

35. The liquor according to claim 34, comprising about 1 liter of the liquor formulation, about 526 mg of the thiamine (B₁), about 10.5 mg of the folic acid (B₉), about 10.5 mg of the pyridoxine (B₆) and about 133.5 mg of the niacin (B₃).

36. A mixer for mixing with a liquor to form a liquor beverage, comprising
a mixer formulation,
a vitamin selected from the thiamine (B₁), allithiamine and combinations thereof,
wherein the mixer has an concentration of thiamine and/or allithiamine such that the liquor beverage has greater than about 0.19 milligrams of the thiamine per gram of ethanol in the liquor beverage and/or greater than about 0.02 milligrams of the allithiamine per gram of ethanol in the liquor beverage, and
folic acid (B₉).

37. The mixer according to claim 36, further comprising pyridoxine (B₆), cyanocobalamin (B₁₂), niacin (B₃) and pantothenic acid.

38. A method for preparing a nutrient-enhanced alcoholic beverage, comprising adding at least one nutrient selected from thiamine (B₁), allithiamine and combinations thereof to a bulk alcoholic beverage formulation during processing of the bulk alcoholic beverage formulation prior to a final filtration step to form a nutrient-enhanced alcoholic beverage.

39. The method according to claim 38, wherein the alcoholic beverage is a liquor, the bulk alcoholic beverage formulation is a bulk liquor formulation, and method further comprising pumping the nutrients into the bulk liquor formulation using a static mixer for blending the nutrients with the bulk liquor formulation, prior to dilution and final filtration of the bulk liquor formulation.

40. The method according to claim 38, wherein the alcoholic beverage is a liquor and the bulk alcoholic beverage formulation is a bulk liquor formulation, and the method further comprises blending the nutrients into a first portion of the bulk liquor formulation in a dosed buffer tank and/or a holding tank with an impeller, and then adding the blended first portion of the bulk liquor formulation and the nutrients to the bulk liquor formulation.

41. The method according to claim 38, wherein the alcoholic beverage is a beer, the bulk alcoholic beverage formulation is a bulk beer formulation, and the method further comprises adding the nutrients in a slurry form and pumping the nutrient slurry into the bulk beer formulation.

42. The method according to claim 38, wherein the alcoholic beverage is a beer, the bulk alcoholic beverage formulation is a beer formulation, and the method further comprises blending a first portion of the bulk beer formulation with the nutrients in a dosing buffer tank and/or a holding tank having an impeller, and adding the blended first portion of the bulk beer formulation and the nutrients back into the bulk beer formulation.

43. A method for preparing a nutrient-enhanced wine, comprising mixing at least one nutrient selected from thiamine (B₁), allithiamine and combinations thereof to a bulk wine formulation during processing of the bulk wine formulation, wherein the nutrients are added in a slurry form, after aging and before bottling of the bulk wine formulation.

44. The method according to claim 43, wherein the nutrients are added prior to filtration.

45. The method according to claim 43, further comprising blending a first portion of the bulk wine formulation with the nutrients in a dosing buffer tank and/or a holding tank having an impeller, and adding the blended first portion of the bulk wine formulation and the nutrients to the bulk wine formulation.

46. A method for preparing a nutrient-enhanced alcoholic mixer formulation, comprising adding at least one nutrient selected from thiamine (B₁), allithiamine and combinations thereof to a bulk alcoholic mixer formulation during processing of the bulk alcoholic mixer formulation prior to a final packaging step to form a nutrient-enhanced alcoholic mixer formulation.
